(19) United States
(12) Patent Application Publication
(10) Pub. No.: US 2019/0295089 A1
(43) Pub. Date: Sep. 26, 2019

(54) TRANSACTION FRAUD DETECTION BASED ON ENTITY LINKING

(71) Applicant: Microsoft Technology Licensing, LLC, Redmond, WA (US)

(72) Inventors: Yuting Jia, Redmond, WA (US); Jayaram NM Nanduri, Issaquah, WA (US); Vijay Narula, Redmond, WA (US); Qiang Li, Redmond, WA (US); Shreya Agarwal, Seattle, WA (US)

(21) Appl. No.: 15/979,297

(22) Filed: May 14, 2018

Related U.S. Application Data
(60) Provisional application No. 62/647,467, filed on Mar. 23, 2018.

(51) Int. Cl. G06Q 20/40; G06Q 20/10; G06N 5/04; G06N 3/02

(52) U.S. Cl. CPC G06Q 20/4016; G06N 3/02; G06N 5/04; G06Q 20/10

(57) ABSTRACT

Methods, systems, and computer program products are provided for transaction fraud detection based on entity linking. Identifying data is collected associated with at least one transaction in a set of fraudulent transactions. A second set of transactions is searched for first linked transactions that include at least some of the identifying data. For each of the first linked transactions, the second set of transactions is recursively searched for additional linked transactions based at least in part on additional identifying data included in each of the first linked transactions. A fraud island is designated to include the at least one transaction, the first linked transactions, and the additional linked transactions. Whether a subsequent transaction is fraudulent is determined based on the fraud island and a transaction fraud risk model.

### CROSS-REFERENCE TO RELATED APPLICATIONS

This application claims priority to U.S. Provisional Patent Application No. 62/647,467, filed Mar. 23, 2018, the entirety of which is incorporated by reference herein.

### BACKGROUND

Electronic commerce (“E-commerce”) is a form of commerce transacted online, generally via the Internet. E-commerce today is typically conducted over the World Wide Web using a personal computer, smart phone, a tablet computer, or other device that includes a web browser or other Internet-enabled application. The user of one of these devices can navigate to and connect to an e-commerce platform. An e-commerce platform is a form of network accessible system for transacting business, or otherwise providing services to users of the platform. The e-commerce platform enables on-demand access to goods and services online. An e-commerce platform typically consists of a shared pool of computing resources, such as computer networks, servers, storage, applications, and services, that can be rapidly provisioned to, among other things, serve webpages to users, and process user transactions. Notable examples of such e-commerce platforms include, Microsoft® Online Store, Xbox Live®, Amazon.com®, or eBay®.

After connecting to the e-commerce platform, the user may browse through the product or service offerings shown thereon, and opt to purchase one or more of the offered products or services. As part of the transaction, the e-commerce platform will solicit payment from the user, and the user will typically provide credit card or other payment information to effect payment.

Just as with conventional “brick-and-mortar” establishments, however, credit card fraud can be a problem. Indeed, fraud and abuse in the e-commerce context is even more prevalent, due to the virtual presence of the transaction participants. Fraudsters (persons who attempt or actually commit a fraud) can be physically located anywhere in the world, and need not have a physical credit card or other payment instrument to commit a fraudulent transaction. Fraudsters can also take advantage of hijacked accounts, or other forms of identity theft, in addition to using stolen credit card information. In addition to credit card or other types of financial fraud, e-commerce platforms are also susceptible to other forms of fraudulent abuse as well. Such abuse can cause excessive consumption of storage, processing and human resources.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided that address issues related to fraud and abuse of an e-commerce platform. In one implementation, a fraud detection system of an e-commerce platform is enabled to establish links between entities directly or indirectly associated with activities identified as fraudulent or abusive. The collection of linked entities is known as a “fraud island.” An entity's presence in a fraud island is highly predictive of future fraudulent activity.

In one example aspect for determining a fraud island, a set of known fraudulent transactions is determined. Information associated with transactions of the set is collected, such as an account identifier (i.e., account number or other unique account identifier), a device ID or other type of device fingerprint (e.g., a device serial number, an IP address, a combination thereof, etc.), an email address, and/or a payment instrument identification used for that transaction. Examples of a payment instrument include credit card information associated with the transaction, or a cryptographic hash of such information. A body of transactions is searched to determine if any of those transactions used any of the collected information. A transaction (in the body of transactions) determined to have used any of the collected information is considered linked to the original, fraudulent transaction.

For each additional linked transaction, the process of collecting information, searching the body of transactions, and identifying further transactions may be repeated recursively, any number of times. In particular, the account, device ID, email address and payment instrument ID for the additional transaction may be compared against all the other transactions to establish additional links thereby. After recursively searching the body of transactions, a pool of transactions is formed that contains all of the transactions linked together through the transaction identifiers. This pool of transactions is referred to as a “fraud island.”

Further features and advantages of the invention, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1A shows a block diagram of a system for fraud detection on an e-commerce platform, according to an example embodiment.

FIG. 1B shows a block diagram of a fraud detection system configured to generate fraud islands and determine fraudulent transactions based thereon, according to an example embodiment.

FIG. 2 shows a flowchart of various stages of use of an e-commerce platform, according to an example embodiment.

FIG. 3 shows example transaction data collected by an e-commerce platform during transactions conducted on the platform, according to an example embodiment.

FIG. 4 shows a flowchart of an example method for generating fraud islands and determining fraudulent transactions based thereon, according to an example embodiment.

FIG. 5 shows a subset of linked transactions identified as a fraud island in a larger set of transactions, according to an example embodiment.

FIG. 6A shows a flowchart of a method for determining fraud island statistics and features, according to an example embodiment.

FIG. 6B shows a flowchart of a method for incorporating determined fraud island features in a feature store for use by a transaction fraud risk model, according to an example embodiment.

FIG. 6C shows a flowchart of a method for providing determined fraud island features to a feature store in an aggregated form, according to an example embodiment.

FIG. 7 shows a flowchart of a method for determining whether a transaction determined to be associated with a fraud island is fraudulent, according to an embodiment

FIG. 8 is a block diagram of an example processor-based computer system that may be used to implement various embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. INTRODUCTION

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### II. EXAMPLE EMBODIMENTS

Embodiments described herein enable e-commerce platforms to establish links between entities associated with known fraudulent or abusive activities. An “entity” is information associated with a transaction, such as an account identifier, a payment instrument, an email or other type of address (e.g., a phone number), and a device footprint. The collection of linked entities is known as a “fraud island”, and an entity's presence in a fraud island is highly predictive of future fraudulent activity. Establishing entity links is a type of fraud feedback that can be used to create features suitable for evaluating subsequently received transaction risks for linked entities, even where some of the entities are involved in no prior instances of fraud.

Establishing entity links is a type of fraud feedback that can be used to create features suitable for evaluating current transaction risks for linked entities, even where some of the entities have no prior history of fraud. For example, fraudsters often create numerous accounts for committing online fraud and abuse. Newly created accounts have no history of fraud or abuse. Nevertheless, sometimes fraudsters make a mistake or are forced to re-use devices, email addresses, or payment instruments for establishing such new accounts. For instance, suppose that the email address associated with a known fraudulent transaction is re-used to create a new account. Even though the new account has no history, its use is much more likely to be fraudulent because of the link to a fraudulent transaction or entity. Embodiments disclosed herein determine links between such entities to generate fraud islands, which may be used in the identifying of fraudsters.

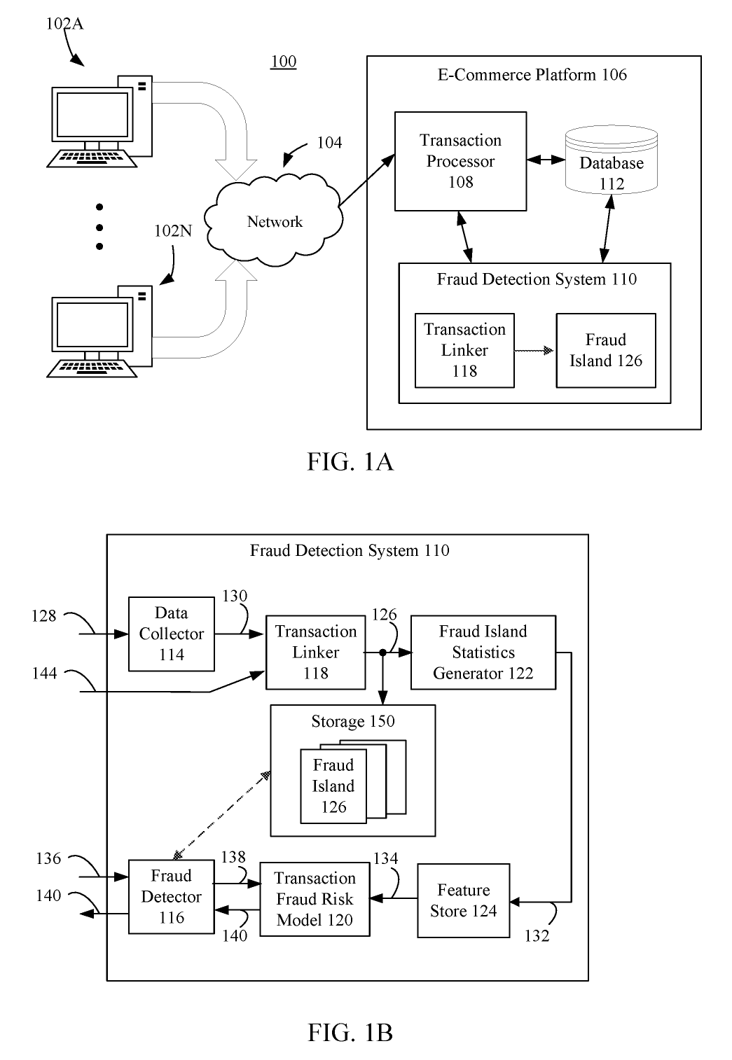

For example, FIG. 1A shows a block diagram of a system 100 for entity linking on an e-commerce platform, according to an embodiment. System 100 includes a plurality of user devices 102A-102N, a network 104, and an e-commerce platform 106. E-commerce platform 106 includes a transaction processor 108, a fraud detection system 110, and a database 112. Fraud detection system 110 includes a transaction linker 118 configured to generate a fraud island 126 based on a history of transactions. Fraud island 126 contains at least one transaction determined to be fraudulent, and one or more further transactions determined to be linked to the fraudulent transaction(s) by transaction linker 118. Fraud island 126 may be used by fraud detection system 110 to determine whether subsequently received transactions are fraudulent.

Fraud detection system 110 may be configured in various ways to perform such functions. For instance, fraud detection system 110 may be configured as shown in FIG. 1B. FIG. 1B shows a block diagram of fraud detection system 110 configured to generate fraud islands and determine fraudulent transactions, according to an embodiment. As shown in FIG. 1B, fraud detection system 110 includes a data collector 114, a fraud detector 116, transaction linker 118, a transaction fraud risk model 120, an optional feature store 124, and storage 150. Storage 150 stores one or more fraud islands, including fraud island 126. FIGS. 1A and 1B are described in detail as follows.

User devices 102A-102N include the computing devices of users (e.g., individual users, family users, enterprise users, governmental users, etc.) that access e-commerce platform 106 via network 104. Although depicted as a desktop computer, user devices 102A-102N may include other types of computing devices suitable for connecting with e-commerce platform 106 via network 104. User devices 102A-102N may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. Note that the variable “N” is appended to reference numerals for illustrated components to indicate that the number of such components is variable, with any value of 2 and greater. Note that for each distinct component/reference numeral, the variable “N” has a corresponding value, which may be different for the value of “N” for other components/reference numerals. The value of “N” for any particular component/reference numeral may be less than 10, in the 10 s, in the hundreds, in the thousands, or even greater, depending on the particular implementation.

Network 104 may comprise one or more networks such as local area networks (LANs), wide area networks (WANs), enterprise networks, the Internet, etc., and may include one or more of wired and/or wireless portions.

E-commerce platform 106 includes transaction processor 108, database 112, and fraud detection system 110. Transaction processor 108 receives electronic transaction requests from users at user devices 102A-102N, and executes the transactions. For instance, received transaction requests may be requests to purchase products and/or services. Transaction processor 108 is configured to process such requests by enabling the purchases to be made, assuming that transaction processor 108 determines that a purchaser user is properly identified and a valid payment instrument is provided in the transaction request. In embodiments, transaction processor 108 includes and/or communicates with fraud detection system 110 to determine whether a received transaction request is for a non-fraudulent transaction. If fraud detection system 110 determines the transaction is non-fraudulent, transaction processor 108 enables the transaction to be made. If fraud detection system 110 determines the transaction is fraudulent, transaction processor 108 denies/rejects the transaction request. Database 112 stores information of each of the transactions processed by transaction processor 108, including transactions determined to be fraudulent and transactions believed to not be fraudulent.

Transaction processor 108 may be implemented by a web site, web server, web service, and/or other transaction handling application. Note that although depicted as a monolithic component, transaction processor 108 may be embodied in any number of computing devices such as servers, and may include any type and number of other resources, including resources that facilitate communications with and between the computing, user devices 102A-102N, database 112, fraud detection system 110, and any other necessary components internal or external to e-commerce platform 106. In embodiments, servers implementing transaction processor 108 may be organized in any manner, including being grouped in server racks (e.g., 8-40 servers per rack, referred to as nodes or “blade servers”), server clusters (e.g., 2-64 servers, 4-8 racks, etc.), or datacenters (e.g., thousands of servers, hundreds of racks, dozens of clusters, etc.). In an embodiment, the servers of transaction processor 108 may be co-located (e.g., housed in one or more nearby buildings with associated components such as backup power supplies, redundant data communications, environmental controls, etc.) to form a datacenter, or may be arranged in other manners. Accordingly, in an embodiment, transaction processor 108 may comprise a datacenter in a distributed collection of datacenters. Likewise, although depicted as a single database, database 112 of e-commerce platform 106 may comprise one or more databases that may be organized in any manner both physically and virtually. In an embodiment the servers of database 112 may be co-located in a manner like transaction processor 108, as described above.

Although fraud detection system 110 is depicted as being separate from database 112, it will be apparent to persons skilled in the art that operations of fraud detection system 110 (as described in further detail elsewhere herein) may be performed in database 112, and/or some other component. For example, fraud detection system 110 operations may be incorporated into a stored procedure of an SQL (structured query language) database, in an embodiment.

In an embodiment, using a browser of user device 102A, a user may navigate to a URL (uniform resource locator) associated with e-commerce platform 106, and establish a connection therewith via network 104. In a typical use of e-commerce platform 106, users sign up for an account on e-commerce platform 106, and subsequently interact with e-commerce platform 106 to purchase goods and/or services. Over the course of time, transaction processor 108 stores numerous records of the transactions to database 112. Such transaction records may include identifying information associated with each transaction. For example, for each transaction, transaction processor 108 may store an account number or other identifier for the transaction, a device ID (identifier) for a device used by the user to perform the transaction, an email address used or submitted by the user, a payment instrument ID used by the user to pay for the transaction, among other attributes.

Some of the transactions may turn out to be fraudulent. For instance, a person may report their payment instrument (e.g., credit card number) as having been used in a transaction in a fraudulent manner by someone else, a person may report their credentials having been stolen or compromised and those credentials may have been used in a transaction without their knowledge, etc. Transactions associated with these and any other type of fraudulent purchase may be identified as fraudulent transactions.

In embodiments, fraud detection system 110 of e-commerce platform 106 is configured to establish links between transactions in database 112 that include at least one identified fraudulent transaction, the linked transactions collectively forming a fraud island. In an embodiment, fraud detection system 110 may be further configured to detect potentially fraudulent activity in real-time based at least in part on one or more fraud risk scores generated by a suitable fraud risk model that incorporates features of a fraud island. For instance, transaction fraud risk model 120 may be a fraud risk model that may be used to determine (e.g., predict) whether received transactions are fraudulent, such as by indicating a percentage likelihood the received transaction is fraudulent. Transaction fraud risk model 120 may be enhanced with features of fraud island 126 to further improve the ability of transaction risk model 120 determine whether a transaction linked to fraud island 126 is fraudulent.

Transaction fraud risk model 120 may be configured in various ways. In one embodiment, transaction fraud risk model 120 may be a machine learning model such as a gradient boosting decision tree, an artificial neural network, a deep neural network or some other type of machine learning classifier. Note that the disclosed embodiments are not limited to any particular type or form of fraud risk model employed by e-commerce platform 106.

For instance, transaction fraud risk model 120 may have the form of an algorithm. The algorithm may have any form, such as including a sequence of factors, each of which may be scaled or unscaled, that are combined to together. The algorithm may be linear or non-linear. Information from a received transaction may be received as inputs to transaction fraud risk model 120, and transaction fraud risk model 120 generates an output indication of whether the input transaction is fraudulent or not. Each entity of the information of the transaction may be input to one or more of the algorithm factors, and the outputs of the factors are combined (e.g., summed, subtracted, etc.) to generate the output indication.

In an embodiment, when a received transaction is determined to be linked to a fraud island, features of the fraud island may be provided as inputs to transaction fraud risk model 120, with or without the information of the transaction itself, and transaction fraud risk model 120 may generate the output indication of whether the linked transaction is fraudulent or not with a higher accuracy than without the fraud island factors.

To generate a fraud island, such as fraud island 126, data collector 114 receives fraudulent transaction(s) 128 from database 112, as shown in FIGS. 1A and 1B. Data collector 114 of fraud detection system 110 retrieves entities from each fraudulent transaction of fraudulent transaction(s) 128, such as the account identifier, device ID, email address, and payment instrument ID, and may do this for transactions having data stamps as occurring during a predetermined time period, such as the prior 90 days. A “known” or “identified” fraudulent” transaction is any past transaction that has been confirmed fraudulent (e.g., was subject to a charge back from the bank). As shown in FIG. 1B, data collector 114 generates fraudulent transaction information 130, which includes the extracted entities.

Transaction linker 118 receives fraudulent transaction information 130 and a second transaction set 144 from database 112. Second transaction set 144 includes further transactions stored in database 112, and may include some or all transactions processed by transaction processor 108 and stored by database 112 (e.g., processed during a predetermined time period). Transaction linker 118 is configured to search second transaction set 144 for other transactions that include one of the identifiers. For example, suppose a known fraudulent transaction is associated with a particular email address. Transaction linker 118 of fraud detection system 110 may be configured to second transaction set 144 for other transactions that include that email address. Any other transaction that includes or used the email address is designated as “linked” to the original, known fraudulent transaction.

Transaction linker 118 may be further configured to recursively search second transaction set 144 to identify even more links. Using the example above, the transactions that share an email address with a known fraudulent transaction may each likewise have a corresponding account identifier, device ID and payment instrument ID. Transaction linker 118 may be configured to search second transaction set 144 for transactions that match at least one of these other identifiers. Each additional linked transaction then provides additional search parameters for a recursive search of the entire set of transactions that may be performed. In this manner, fraud detection system 110 links entities and transactions via their shared attributes. A collection of such linked entities forms a fraud island such as fraud island 126. Any number of one or more searches may be recursively performed, in embodiments, to increase the size of a fraud island. In one embodiment, a predetermined number of search iterations is performed during the recursive search. In other embodiments, the recursive searching is continued until no additional transactions are found that can be linked, or until a predetermined maximum number of transactions are linked. As shown in FIG. 1B, transaction linker 118 generates fraud island 126, which includes an indication of the linked transactions and their corresponding transaction information. Transaction linker 126 stores fraud island 126 in storage 150 with any other fraud islands determined based on alternative sets of fraudulent transactions.

In an embodiment, fraud detection system 110 is further configured to determine statistics for each fraud island. For example, as shown in FIG. 1B, fraud island statistics generator 112 receives fraud island 126. In an embodiment, fraud island statistics generator 112 is configured to determine statistics for fraud island 126, such as, for example, a date of the first fraudulent transaction in fraud island 126, the date of the most recent fraudulent transaction in fraud island 126, the number of fraudulent transactions in fraud island 126, and the total monetary amount of fraudulent transactions for fraud island 126. These statistics may be updated daily or at some other suitable interval by fraud detection system 110. As is described in further detail below, these pre-calculated fraud island statistics may be usefully employed to determine a fraud risk in real-time during a pending transaction.

Note that fraud island statistics generator 112 may be configured to determine further types of statistics from fraud island 126, and those statistics may be used to determine fraud risk for transactions linked to fraud island 126. For example, fraud island statistics generator 112 may generate, for each fraud island stored in storage 150, a total number of transactions linked in the fraud island, the total number of good (i.e., non-fraudulent) transactions in the fraud island, the total number of bad (i.e., fraudulent) transactions in the fraud island, the number of transactions in an unknown state (i.e., neither good or bad) in the fraud island, the total dollar amount of island transactions in the fraud island, the good (i.e., non-fraudulent) transaction dollar amount of transactions in the fraud island, the bad transaction dollar amount of transactions in the fraud island, the dollar amount for transactions in an unknown state in the fraud island, and the number of days since the last fraud in the fraud island. As shown in FIG. 1B, fraud island statistics generator 112 outputs the determined statistics as fraud risk model features 132. As further described, fraud risk model features 132 may be output in an aggregated or non-aggregated form.

In an embodiment, feature store 124 receives and maintains fraud risk model features 132 for fraud islands, including fraud island 126, in storage 150 or separate storage. Feature store 124 is configured to provide the fraud risk model features upon request to transaction fraud rest model 120 as input fraud island features 134, to be used by transaction fraud rest model 120 to evaluate whether a received transaction is fraudulent.

In particular, fraud detector 136 of FIG. 1B may receive an input transaction 136 from transaction processor 108 (FIG. 1A) to evaluate for fraud. For instance, input transaction 136 may be received at purchase time, and fraud detector 116 may determine a fraud risk inherent to input transaction 136. Fraud detector 116 may determine whether input transaction 136 includes an entity in a particular fraud island in storage 150. If fraud detector 116 determines input transaction 136 includes an entity in fraud island 126, fraud detector 116 may send a fraud risk determination request 138 to transaction fraud rest model 120, which may also cause feature store 124 to provide fraud statistics for fraud island 126 as fraud island input features 134 to transaction fraud risk model 120. Transaction fraud rest model 120 is configured to determine a risk of fraud for input transaction 136 based at least in part on fraud island input features 134 (and optionally also upon information of input transaction 136 that may be provided in fraud risk determination request 138.

Fraud island input features 134 may be used in transaction fraud rest model 120 in any manner. For instance, transaction fraud rest model 120 may have the form of an algorithm that includes one or more factors, with each factor including one or more variables and/or coefficients. In such an embodiment and/or in other embodiments, each of the fraud statistics included in fraud island input features 134 may be input to transaction fraud rest model 120 as a value for a variable, a value for a coefficient, a value for a decision step, and/or may be input to transaction fraud rest model 120 in any other manner and/or for any other purpose. As shown in FIG. 1B, transaction fraud rest model 120 generates a transaction risk score 140, which indicates a fraud risk for input transaction 136. Transaction risk score 140 may have any suitable form, including an indication of fraud, an indication of no fraud, or a score representing the probability that input transaction 136 is fraudulent.

Fraud detector 116 of FIG. 1B receives transaction risk score 140, and provides transaction risk score 140 to transaction processor 108 of FIG. 1A. Based on transaction risk score 140, transaction processor 108 may allow the transaction or deny the transaction. In the case where transaction risk score 140 is a probability, transaction processor 108 may allow or deny the transaction based on a predetermined threshold value (e.g., 50% or other value). For instance, if transaction risk score 140 has a value greater than the threshold (e.g., relatively high probability of fraud), transaction processor 108 may deny the transaction. Transaction processor 108 may alternatively take another action to mitigate the risk, such as placing a hold on the transaction or flagging it for human review if transaction risk score 140 is within a predetermined range indicating fraud to be indeterminate.

Storage 150 may include one or more of any type of physical storage mechanism, including a magnetic disc (e.g., in a hard disk drive), an optical disc (e.g., in an optical disk drive), a magnetic tape (e.g., in a tape drive), a memory device such as a RAM (random access memory) device, and/or any other suitable type of physical storage device.

Note that foregoing general description of the operation of system 100 provided for illustration, and embodiments of system 100 may operate in manners different than described above. Furthermore, not all such processing steps need be performed in all embodiments. What follows is discussion of the remaining figures wherein further details of various embodiments of system 100 will be apparent.

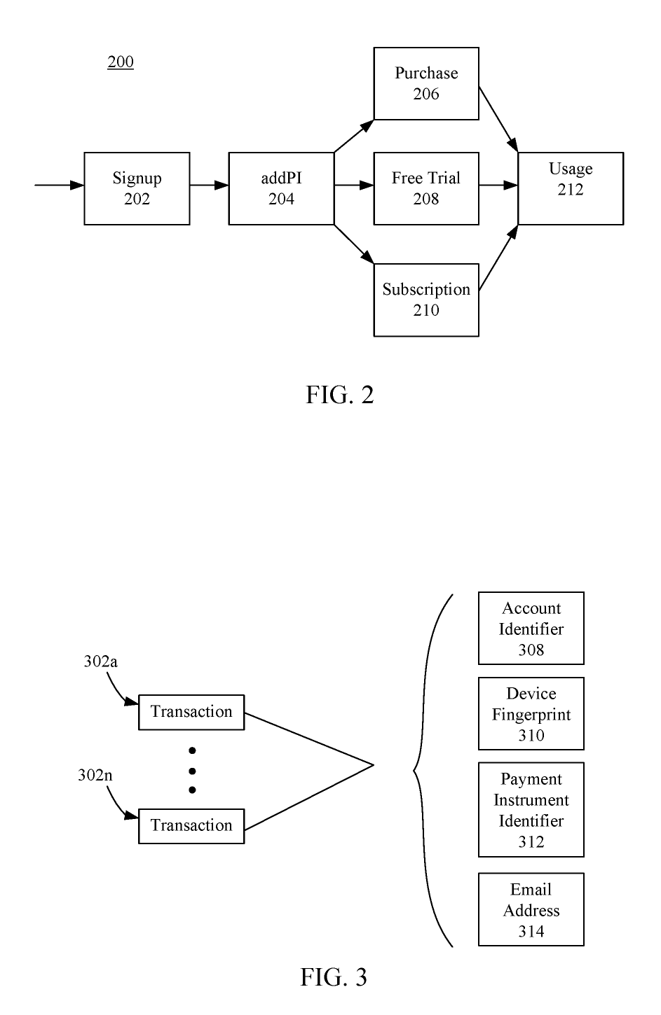

In embodiments, e-commerce platform 106 of system 100 may be used in various ways by a user. For instance, FIG. 2 shows a flowchart 200 of example stages of use of e-commerce platform 106, according to an embodiment. Each stage of flowchart 200 may be performed by data collector 114 of e-commerce platform 106, in an embodiment, including the collection and storage of information. Note that not all stages of flowchart 200 may be performed in all embodiments. Flowchart 200 is described as follows.

Although some e-commerce platforms permit people to use certain aspects of the platform without creating an account or otherwise signing up (e.g. browsing through and/or searching for products or services on the platform), actual transactions typically require the user to create an account as in signup stage 202 of FIG. 2. In signup state 202, the user may provide at least an email address and password they wish to use to log into e-commerce platform 106, and may be asked to provide more information (e.g., profile information, further authentication information, etc.) depending on the configuration of e-commerce platform 106. This signup information may be collected by data collector 114, in an embodiment.

In an embodiment, a next example stage, addPI (“add payment instrument”) stage 204, of e-commerce platform 106 enables the user to associate a payment instrument with their account. In other embodiments, however, e-commerce platform 106 may not require the user to enter payment instrument information until a later stage, such as checkout. In flowchart 200, however, it is assumed addPI stage 204 is performed prior to entering one or more of transaction stages 206, 208 or 210. In an embodiment, at addPI stage 204, the user enters, for example, a credit card number, expiration date of the credit card, and the CVV value associated with that card, and e-commerce platform 106 saves that information to the user's account. In another embodiment, the user may instead enter information associated with a gift card or gift certificate, or establish some other means of paying for goods and services such as providing bank account and ACH routing numbers. This payment information may be collected by data collector 114, in an embodiment.

After adding a payment instrument to the account, the process flow of flowchart 200 may continue to one or more of transactions stages 206, 208 or 210. In particular, the user may elect to make a purchase at purchase stage 206, start a free trial at free trial stage 208 or start a subscription at subscription stage 210. Purchase stage 206 is generally associated with the procurement of goods such as books or other merchandise including downloadable merchandise such as software, music or movies. Free trial stage 208 and subscription stage 210, by contrast, are each generally associated with a service provided by or in association with e-commerce platform 106. For example, Microsoft® Xbox Live® is an online multiplayer gaming and digital media delivery service. A subscription to Xbox Live® is required to participate in many popular online multiplayer games. Subscriptions services like Xbox Live® are often offered on a free trial basis allowing users to evaluate the usefulness and value of the service prior to signing up for a subscription. Bearing this example in mind, after addPI stage 204, a user may enter free trial stage 208 to signup up for a free trial of the service. Alternatively, or perhaps sometime after free trial stage 208, the user may elect to pay for a subscription at subscription stage 210. In an embodiment, data collector 114 may collect the purchase information of purchase stage 206, the indication of the free trial being initiated at free trial stage 208, and the indication of a started subscription at subscription stage 210.

Usage stage 212 of flowchart 200 follows any of purchase stage 206, free trial stage 208, or subscription stage 210 that are performed. That is, the service or product is bought or subscribed to in one or more of transaction stages 206, 208 or 210, is used or otherwise consumed in usage stage 212. Accordingly, usage stage 212 may be performed by the service or product, and data collector 114 may be configured to collect data from the service or product regarding the usage.

Accordingly, at each of stages 202-212, embodiments may capture, collect, receive or otherwise obtain data associated with each stage or transaction. For example, and as described above, data collector 114 of e-commerce platform 106 of FIG. 1A may capture the IP address and IP address geolocation of user device 102A during each stage of use depicted in flowchart 200. FIG. 3 illustrates various types of entity or transactions information that may be collected in one or more embodiments. Such information may be collected by data collector 114 in an embodiment. FIG. 3 is described as follows.

In FIG. 3, transactions 302a-302n are each a transaction in which a product or service is purchased by a user. Transactions 302a to 302n may each have associated with them one or more data fields, or identifiers, that form part of the corresponding transaction. For example, and as described above, each of transactions 302a to 302n may be associated with one or more of an account identifier 308, device fingerprint 310, payment instrument identifier 312, or email address 314.

Device fingerprint 310 includes information that may be collected/maintained about a computing device that may be used to uniquely identify the computing device. In an embodiment, e-commerce platform 106 may determine a device fingerprint 310 for a computing device using, for example, the IP address, IP address geolocation and other available device information, as would be known to persons skilled in the relevant art(s).

In an embodiment, payment instrument identifier 312 is an identifier (e.g., a word, a number, an alphanumeric code, etc.) that may be used to identify a particular method of payment associated with the given transaction. For example, payment instrument identifier 312 may comprise a credit card number. In practice, storing a credit card number may present a security risk, and in other embodiments, payment instrument identifier 312 may comprise a cryptographic hash of the credit card number, and/or other information associated with the particular payment instrument used in the transaction.

As described above, e-commerce platform 106 captures, collects, receives, determines, calculates, or otherwise obtains an account identifier, e-mail address, device fingerprint, and/or payment instrument information associated with actions taken by the user. It should be understood, however, that these types of identifiers and other data are merely exemplary, and other types of data may be collected and stored by data collector 114 of e-commerce platform 106. It should likewise be understood that data that is collected or determined does not necessarily correspond to a particular user or person, but rather the use of a particular account. Indeed, embodiments may detect fraudulent activities with, for example, a hijacked account where the “user” is not the owner of the account, but a fraudster at some other location.

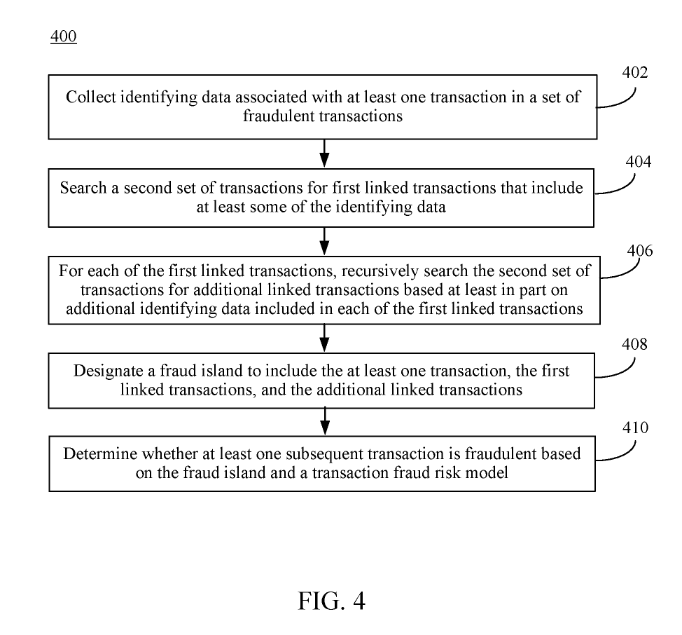

In embodiments, e-commerce platform 106 determines transactions to include in a fraud island in various ways. For instance, FIG. 4 shows a flowchart 400 of an example method for generating fraud islands and determining fraudulent transactions based thereon, according to an example embodiment. In an embodiment, e-commerce platform 106 may operate according to flowchart 400. Note that steps 402-408 of flowchart 400 may be performed as background processing, any time prior to the actual evaluation of incoming transactions for fraud, while step 410 may be performed in real-time, to evaluate incoming transactions for fraud, and thereby allow or deny them. As such, step 402-408 and step 410 may be considered as directed to separate embodiments, or may be performed in sequence as shown in FIG. 4 as a continuous embodiment. Other structural and operational embodiments will be apparent to persons skilled in the relevant art(s) based on the following discussion regarding flowchart 400 and e-commerce platform 106.

Flowchart 400 begins at step 402. In step 402, identifying data associated with at least one transaction in a set of fraudulent transactions is collected. In an embodiment, data collector 114 (FIG. 1B) receives fraudulent transaction(s) 128. Data collector 114 may retrieve certain information or data associated with known fraudulent transactions of fraudulent transaction(s) 128 going back for a predetermined period of time. For example, data collector 114 may retrieve the account identifier, device ID, email address and payment instrument ID for every known fraudulent transaction in database 112 for the prior 90 days. As described above, a “known fraudulent” transaction is any transaction previously determined to be fraudulent. As shown in FIG. 1B, data collector 114 generates fraudulent transaction information 130, which includes the extracted entities.

Flowchart 400 continues at step 404. At step 404, a second set of transactions is searched for first linked transactions that include at least some of the identifying data. In an embodiment, transaction linker 118 receives fraudulent transaction information 130. Transaction linker 118 searches the transaction records of fraudulent transaction information 130 covering a predetermined time period (e.g., the last 90 days) for other transactions that include one of the identifiers. For example, suppose a known fraudulent transaction is associated with a particular email address. Transaction linker 118 may be configured to search a body of transactions (e.g., in database 112) for other transactions that include that email address. Any other transaction that includes or uses the email address is said to be “linked” to the original, known fraudulent transaction, and all such linked transactions comprise a “fraud island.” Such linked transactions determined in step 404 comprise first linked transactions.

Continuing to step 406, the second set of transactions are recursively searched, for each of the first linked transactions, for additional linked transactions based at least in part on additional identifying data included in each of the first linked transactions. In an embodiment, transaction linker 118 of e-commerce platform 106 uses identifying information associated with the first linked transactions to determine a set of additional linked transactions. Using the example above, the first linked transactions that share an email address with a known fraudulent transaction themselves include an account identifier, device ID and payment instrument ID. In step 406, transaction linker 118 may use such identifying information to determine a set of additional linked transactions. Furthermore, transaction linker 118 may recursively search all transactions as described immediately above, thereby identifying all transactions that may be linked by any common identifying information or data.

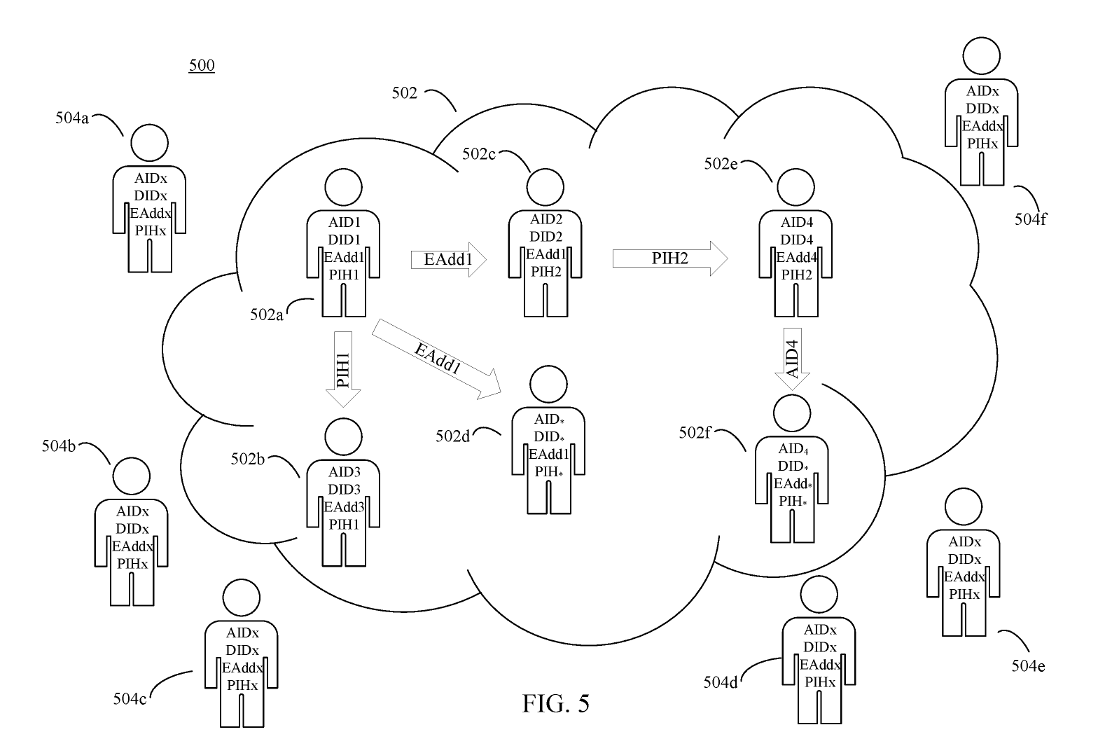

At step 408, a fraud island is designated to include the at least one transaction, the first linked transactions, and the additional linked transactions. In an embodiment, transaction linker 118 outputs fraud island 126, which includes the known fraudulent transactions, the first linked transactions, and the additional linked transactions. As described above, a fraud island comprises the complete set of linked transactions. FIG. 5 shows an example set of transactions 500 comprising unlinked transactions 504a-504f, and linked transactions 502a-502f of fraud island 502 in a pictorial form. The transactions 500 of FIG. 5, and the means by which embodiments may determine transaction membership in fraud island 502, is described as follows in the context of flowchart 400 of FIG. 4.

As described above in relation to FIG. 4, determining fraud island membership begins with one or more transactions previously determined to have been fraudulent. Suppose for a moment, that no links have been established between any of the transactions 502a-502f and 504a-504f in FIG. 5. Further suppose, that transaction 502a was previously determined to be a fraudulent transaction. Beginning at step 402, flowchart 400 as depicted in FIG. 4, data collector 114 may retrieve information or data associated with transaction 502a. For example, data collector 114 may retrieve the account identifier, device ID, email address and payment instrument ID for transaction 502a. Such information is illustrated in transaction 502a of FIG. 5, and denoted AID1, DID1, EAdd1 and PIH1, respectively.

Continuing at step 404 of flowchart 400, transaction linker 118 is configured to search the other transaction records for other transactions that include at least one of AID1, DID1, EAdd1 and PIH1. For example, transaction linker 118 may begin by searching for all transactions that match the payment instrument hash value (PIH1) of transaction 502a. As depicted in FIG. 5, transaction linker 118 identifies transaction 502b as a transaction with the same payment instrument hash, PIH1, thereby establishing a link between the transactions.

After identifying all transactions that include the same payment instrument hash value, PIH1, as transaction 502a, transaction linker 118 searches for all transactions that include at least one of the other identifiers. For example, transaction linker 118 may next search the transactions shown in FIG. 5 for transactions that include the email address of transaction 502a, EAdd1. When performed, the search reveals transactions 502c and 502d as using the same email address, EAdd1, as transaction 502a, and thus establishes links between transaction 502a and 502c, and transaction 502a and 502d.

For each transaction linked to transaction 502a, step 406 of flowchart 400 may be performed by transaction linker 118 as a recursive search of all transactions based on information or identifiers included in each of the linked transactions. For example, transaction 502c links back to known fraudulent transaction 502a through a common email address, EAdd1. At step 406 of flowchart 400, transaction linker 118 may search the remaining transactions for other transactions that include at least one of the account ID (AID2), device ID (DID2), and/or payment instrument hash (PIH2). Note, in another embodiment, transaction linker 118 may perform the recursive search for transactions that include common email address, EAdd1, depending on whether the recursive search algorithm proceeds in a depth first manner, or a breadth first manner, as will be understood by persons skilled in the relevant art(s). For example, as depicted in FIG. 5, searching transactions by search key PIH2 establishes a link between transaction 502c and 502e.

Upon completion of the recursive search, e-commerce platform 106 may designate a fraud island as described above in relation to step 408 of flowchart 400. In particular, e-commerce platform 106 may designate transactions 502a through 502f as comprising fraud island 502 based upon the fact that each of the transactions is linked to at least one other transaction in fraud island 502. Transactions 504a-504f are not depicted in FIG. 5 as being the member of any particular fraud island since no links were found between those transactions and any of those in fraud island 502. However, this is exemplary only, and such transactions may be members of a different fraud island that is not illustrated in FIG. 5.

Linking a transaction to a fraud island increases the probability that the transaction is itself fraudulent. This is particularly true where many known fraudulent transactions are members of the fraud island. This fact may be usefully exploited to help determine whether a pending transaction is likely to be fraudulent. As described herein, fraud island statistics may be determined by fraud island statistics generator 122 for any given fraud island. Such statistics may be used by fraud island statistics generator 122 to generate fraud risk model features 132 (e.g., an optionally filtered version of the generated fraud island statistics) suitable for input to transaction fraud risk model 120, the output of which is a fraud risk score indicated as transaction risk score 140. In one embodiment, transaction fraud risk model 120 may be a machine learning model such as a gradient boosting decision tree, an artificial neural network, a deep neural network or some other type of machine learning classifier. However, the disclosed embodiments are not limited to any particular type of fraud risk model employed by, for example, e-commerce platform 106.

Depending on context, and as described in further detail below, the fraud risk score may represent different things. Where the score is generated from static fraud island statistics (i.e., considering only historical transactions), the score may represent the probability that a fraud island transaction is fraudulent. Said another way, it is a measure of the risk associated with a transaction being a member of the fraud island.

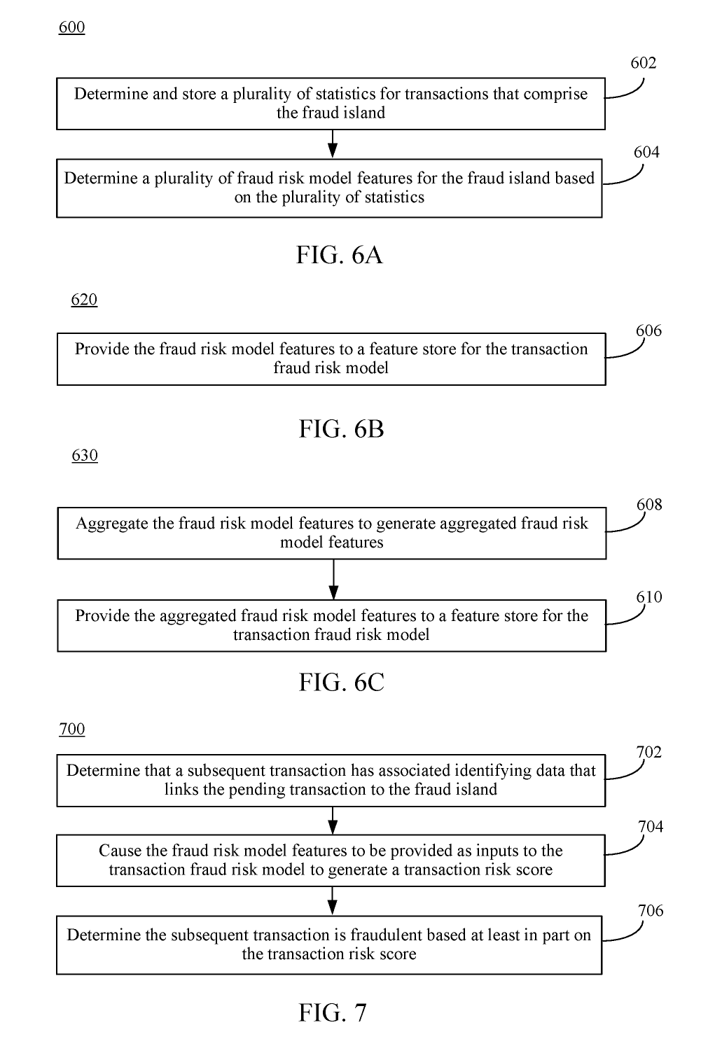

Fraud risk model features 132 may be generated by fraud island statistics generator 122 in any manner. For instance, FIG. 6A shows a flowchart 600 of a method for determining fraud island statistics and features, according to an example embodiment. Flowchart 600 may be performed by fraud island statistics generator 122 in an embodiment. Other structural and operational embodiments will be apparent to persons skilled in the relevant art(s) based on the following discussion regarding flowchart 600.

Flowchart 600 begins at step 602. Step 602 of flowchart 600 begins with the assumption that at least one fraud island has already been determined and designated, such as described above in relation to FIGS. 4 and 5. At step 602, a plurality of statistics is determined and stored for transactions that comprise the fraud island. In an embodiment, fraud island statistics generator 122 receives fraud island 126, and based thereon, generates statistics. Such statistics may include, for example, the date of the first fraudulent transaction in fraud island 126, the date of the most recent fraudulent transaction in fraud island 126, the number of fraudulent transactions and the total dollar amount of fraudulent transaction for fraud island 126, the total number of transactions in fraud island 126, the total number of good (i.e., non-fraudulent) transactions in fraud island 126, the total number of bad (i.e., fraudulent) transactions in fraud island 126, the number of transactions in an unknown state (i.e., neither good or bad) in fraud island 126, the total monetary amount of fraud island 126 transactions, a total monetary amount of the good (i.e., non-fraudulent) transactions of fraud island 126, a total monetary amount of the bad transactions of fraud island 126, a total monetary amount for transactions in an unknown state, a number of days since the last fraud transaction of fraud island 126 was undertaken, and/or any of the statistics mentioned elsewhere herein, or that would become apparent to persons skilled in the relevant art(s) based on the teachings herein. These statistics may be updated daily or at some other suitable interval by fraud island statistics generator 122.

Continuing at step 604 of flowchart 600, a plurality of fraud risk model features is determined for the fraud island based on the plurality of statistics. In an embodiment, Fraud island statistics generator 122 determines fraud risk model features 132, which includes fraud risk model features determined based on the fraud island statistics determined in step 602. Fraud risk model features 132 may be a version of the statistic tailored for use as input to a suitably trained fraud risk model, such as transaction fraud risk model 120, or may include the statistics in an unmodified form.

In an embodiment, the fraud island statistics determined at step 602 and/or the fraud risk model features determined at step 604 are provided to feature store 124 for later retrieval and use. One advantage of such maintenance is that fraud risk model input features may be pre-calculated in an offline, non-production system for later fraud evaluation of incoming transactions in production.

Note that as described above, fraud risk model features 132 may be provided as input to a fraud risk model in a non-aggregated or aggregated form. For instance, FIG. 6B shows a flowchart 620 of a method for incorporating determined fraud island features in a feature store for use by a transaction fraud risk model, according to an example embodiment. In particular, in step 606 of flowchart 620, the fraud risk model features are provided to a feature store for the transaction fraud risk model. As described above, in an embodiment, fraud island statistics generator 112 outputs determined statistics for fraud island 126 as fraud risk model features 132, which are received and maintained by feature store 124.

In contrast, FIG. 6C shows a flowchart 630 of a method for providing determined fraud island features to a feature store in an aggregated form, according to an example embodiment. In particular, flowchart 630 begins with step 608. In step 608, the fraud risk model features are aggregated to generate aggregated risk model features. In an embodiment, fraud island statistics generator 112 may be configured to aggregate the generated statistics/features, and provide the aggregated information in fraud risk model features 132. Such aggregated features may be desirable to reduce a total number of features for input to a transaction fraud risk model. As an example, fraud island statistics generator 112 may generate an aggregate feature referred to as a “fraud rate” for fraud island 126. The fraud rate may be defined as a total monetary amount of the fraudulent transactions in fraud island 126 divided by the total monetary amount of all transactions (fraudulent and non-fraudulent) in fraud island 126. The generated fraud rate represents an aggregation of the total monetary amount of the fraudulent transactions and the total monetary amount of all transactions. It should be understood that such an aggregation is merely exemplary and other forms of aggregated fraud island features may be generated by fraud island statistics generator 112.

Step 608 of flowchart 630 proceeds to step 610. In step 610, the aggregated risk model features are provided to a feature store for the transaction fraud risk model. As described above, in an embodiment, fraud island statistics generator 112 outputs determined statistics for fraud island 126 as fraud risk model features 132, which are received and maintained by feature store 124. Fraud risk model features 132 may include the aggregated risk model features determined in step 608. Referring again to the fraud rate example discussed just above, providing only the calculated fraud rate (an aggregate feature) to the feature store has the advantage that both the total monetary amount of the fraudulent transactions and the total monetary amount of all transactions in fraud island 126 need not be provided to the feature store. This may save storage resources in the feature store, and likewise reduce the number of features for subsequent input to a machine learning model.

Fraud detector 116 of FIG. 1B may operate in any suitable manner to determine whether an input transaction is fraudulent, in embodiments. For instance, FIG. 7 shows a flowchart 700 of a method for determining whether a transaction determined to be associated with a fraud island is fraudulent, according to an embodiment. Other structural and operational embodiments will be apparent to persons skilled in the relevant art(s) based on the following discussion regarding flowchart 700.

Flowchart 700 begins at step 702. In step 702, a subsequent transaction is determined to have associated identifying data that links the pending transaction to the fraud island. In an embodiment, fraud detector 116 may determine whether an incoming transaction, input transaction 136, is the member of a fraud island. This may be accomplished by determining whether any of the entities associated with the incoming transaction (e.g. account ID, device ID, email address, or payment instrument identifier) match any of the attributes in one or more transactions in a fraud island. In one embodiment, fraud detector 116 may compare information of input transaction 136 to the entities of the fraud islands in storage 150. In another embodiment, fraud detector 116 requests that transaction linker 118 perform the comparison. When input transaction 136 is determined to include one or more entities of a particular fraud island, and thus is linked to the fraud island, flowchart 700 continues at step 704.

At step 704, the fraud risk model features are caused to be provided as inputs to the transaction fraud risk model to generate a transaction risk score. As described above, if fraud detector 116 determines input transaction 136 includes an entity in fraud island 126, fraud detector 116 may send a fraud risk determination request 138 to transaction fraud rest model 120, which may also cause feature store 124 to provide fraud statistics for fraud island 126 as fraud island input features 134 to transaction fraud risk model 120. Transaction fraud rest model 120 is configured to determine a risk of fraud for input transaction 136 based at least in part on fraud island input features 134 (and optionally also upon information of input transaction 136 that may be provided in fraud risk determination request 138.

In step 706, the subsequent transaction is determined to be fraudulent based at least in part on the transaction risk score. In an embodiment, fraud detector 116 receives transaction risk score 140 generated by transaction fraud rest model 120, which indicates a fraud risk for input transaction 136. Fraud detector 116 provides transaction risk score 140 to transaction processor 108 of FIG. 1A. Based on transaction risk score 140, transaction processor 108 may allow or may deny the transaction.

Note that foregoing general description of the operation of system 100 is provided for example, and embodiments of system 100 may operate in manners different than described above. Furthermore, not all steps of flowcharts 400, 600, 620, 630, and 700 need to be performed in all embodiments. Furthermore, the steps of flowcharts 400, 600, 630, and 700 may be performed in orders different than shown in some embodiments.

### III. EXAMPLE COMPUTER SYSTEM IMPLEMENTATION

User device(s) 102A-102N, e-commerce platform 106, transaction processor 108, fraud detection system 110, data collector 114, fraud detector 116, transaction linker 118, transaction fraud risk model 120, fraud island statistics generator 122, feature store 124, flowchart 400, flowchart 600, flowchart 620, flowchart 630, and flowchart 700 may be implemented in hardware, or hardware combined with software and/or firmware. For example, e-commerce platform 106, transaction processor 108, fraud detection system 110, data collector 114, fraud detector 116, transaction linker 118, transaction fraud risk model 120, fraud island statistics generator 122, feature store 124, flowchart 400, flowchart 600, flowchart 620, flowchart 630, and/or flowchart 700 may be implemented as computer program code/instructions configured to be executed in one or more processors and stored in a computer readable storage medium. Alternatively, e-commerce platform 106, transaction processor 108, fraud detection system 110, data collector 114, fraud detector 116, transaction linker 118, transaction fraud risk model 120, fraud island statistics generator 122, feature store 124, flowchart 400, flowchart 600, flowchart 620, flowchart 630, and/or flowchart 700 may be implemented as hardware logic/electrical circuitry.

For instance, in an embodiment, one or more, in any combination, of e-commerce platform 106, transaction processor 108, fraud detection system 110, data collector 114, fraud detector 116, transaction linker 118, transaction fraud risk model 120, fraud island statistics generator 122, feature store 124, flowchart 400, flowchart 600, flowchart 620, flowchart 630, and/or flowchart 700 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

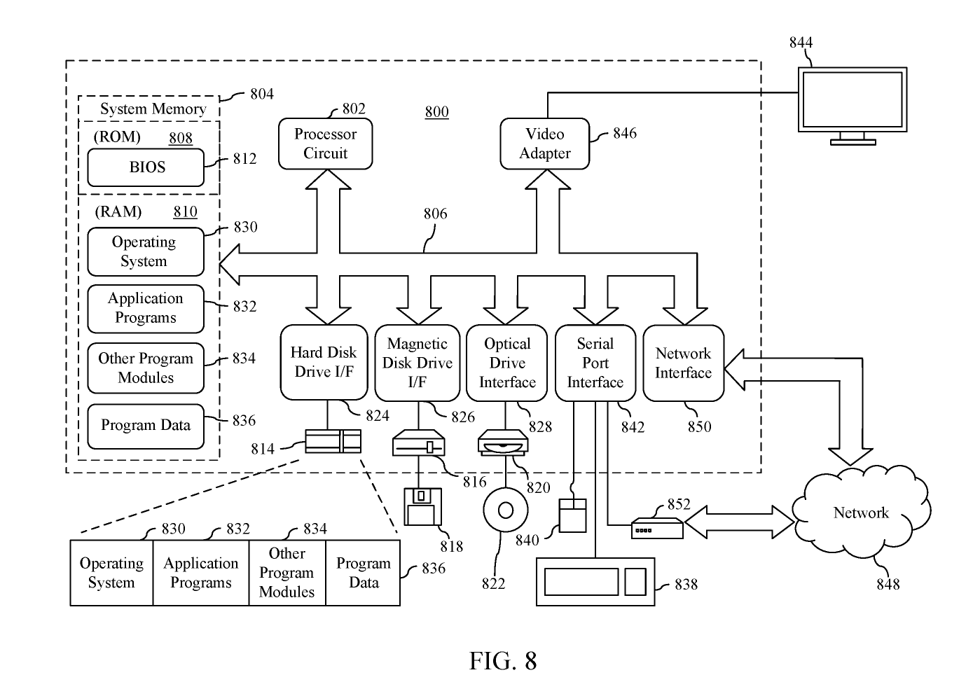

FIG. 8 depicts an exemplary implementation of a computing device 800 in which embodiments may be implemented. For example, user device(s) 102A-102N, transaction servers 108 may each be implemented in one or more computing devices similar to computing device 800 in stationary or mobile computer embodiments, including one or more features of computing device 800 and/or alternative features. The description of computing device 800 provided herein is provided for purposes of illustration, and is not intended to be limiting. Embodiments may be implemented in further types of computer systems, as would be known to persons skilled in the relevant art(s).

As shown in FIG. 8, computing device 800 includes one or more processors, referred to as processor circuit 802, a system memory 804, and a bus 806 that couples various system components including system memory 804 to processor circuit 802. Processor circuit 802 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 802 may execute program code stored in a computer readable medium, such as program code of operating system 830, application programs 832, other programs 834, etc. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random access memory (RAM) 810. A basic input/output system 812 (BIOS) is stored in ROM 808.

Computing device 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 830, one or more application programs 832, other programs 834, and program data 836. Application programs 832 or other programs 834 may include, for example, computer program logic (e.g., computer program code or instructions) for implementing e-commerce platform 106, transaction processor 108, fraud detection system 110, data collector 114, fraud detector 116, transaction linker 118, transaction fraud risk model 120, fraud island statistics generator 122, feature store 124, flowchart 400, flowchart 600, flowchart 620, flowchart 630, and/or flowchart 700 (including any suitable step of flowcharts 400, 600, 630, and 700), and/or further embodiments described herein.

A user may enter commands and information into the computing device 800 through input devices such as keyboard 838 and pointing device 840. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 802 through a serial port interface 842 that is coupled to bus 806, but may be connected by other interfaces, such as a parallel port, game port, or a universal serial bus (USB).

A display screen 844 is also connected to bus 806 via an interface, such as a video adapter 846. Display screen 844 may be external to, or incorporated in computing device 800. Display screen 844 may display information, as well as being a user interface for receiving user commands and/or other information (e.g., by touch, finger gestures, virtual keyboard, etc.). In addition to display screen 844, computing device 800 may include other peripheral output devices (not shown) such as speakers and printers.

Computing device 800 is connected to a network 848 (e.g., the Internet) through an adaptor or network interface 850, a modem 852, or other means for establishing communications over the network. Modem 852, which may be internal or external, may be connected to bus 806 via serial port interface 842, as shown in FIG. 8, or may be connected to bus 806 using another interface type, including a parallel interface.

As used herein, the terms “computer program medium,” “computer-readable medium,” and “computer-readable storage medium” are used to refer to physical hardware media such as the hard disk associated with hard disk drive 814, removable magnetic disk 818, removable optical disk 822, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 832 and other programs 834) may be stored on the hard disk, magnetic disk, optical disk, ROM, RAM, or other hardware storage medium. Such computer programs may also be received via network interface 850, serial port interface 842, or any other interface type. Such computer programs, when executed or loaded by an application, enable computing device 800 to implement features of embodiments described herein. Accordingly, such computer programs represent controllers of the computing device 800.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. ADDITIONAL EXAMPLE EMBODIMENTS

In one embodiment, a fraud detection system comprises: one or more processors; and one or more memory devices accessible to the one or more processors, the one or more memory devices storing program code for execution by the one or more processors, the program code including: a data collector configured to collect identifying data associated with at least one transaction in a set of fraudulent transactions; a transaction linker configured to search a second set of transactions for first linked transactions that include at least some of the identifying data, and to recursively search the second set of transactions for additional linked transactions based at least in part on additional identifying data included in each of the first linked transactions, wherein the at least one transaction, the first linked transactions and the additional linked transactions comprise a fraud island; and a fraud detector configured to determine whether subsequent transactions are fraudulent based on the fraud island and a transaction fraud risk model.

In an embodiment, the identifying data and additional identifying data each comprise at least one of: an account identifier; a device fingerprint; an email address; or a payment instrument identifier.

In an embodiment, the fraud detection system further comprises: a fraud island statistics generator configured to determine and store a plurality of statistics for the transactions that comprise the fraud island, and to determine a plurality of fraud risk model features for the fraud island based on the plurality of statistics.

In an embodiment, the plurality of statistics comprises at least one of: a date of an earliest fraudulent transaction; a date of a most recent fraudulent transaction; a number of fraudulent transactions; a total monetary amount of fraudulent transactions; a total number of transactions; a total number of non-fraudulent transactions; a total number of fraudulent transactions; a number of transactions undeterminable as fraudulent or non-fraudulent; a total monetary amount of the fraud island transactions; a non-fraudulent transaction monetary amount; a fraudulent transaction monetary amount; a monetary amount for the transactions undeterminable as fraudulent or non-fraudulent; and a length of time since a last occurring fraud in the fraud island.

In an embodiment, the fraud island statistics generator is further configured to: provide the fraud risk model features to a feature store for the transaction fraud risk model.

In an embodiment, the transaction linker is further configured to: determine that a subsequent transaction has associated identifying data that links the pending transaction to the fraud island; and the fraud detector is further configured to: cause the fraud risk model features to be provided as inputs to the transaction fraud risk model to generate a transaction risk score; and determine the subsequent transaction is fraudulent based at least in part on the transaction risk score.

In an embodiment, the fraud island statistics generator is further configured to: aggregate the fraud risk model features to generate aggregated fraud risk model features for the fraud island; and provide the aggregated fraud risk model features to a feature store for the transaction fraud risk model.

In an embodiment, the transaction linker is further configured to: determine that a subsequent transaction has associated identifying data that links the pending transaction to the fraud island; the fraud detector is further configured to: cause the fraud island risk score to be input to the transaction fraud risk model to generate a transaction risk score; and determine the subsequent transaction is fraudulent based at least in part on the transaction risk score.

In an embodiment, the transaction fraud risk model comprises at least one of: a gradient decision boosting tree; an artificial neural network; or a deep neural network.

In another embodiment, a computer-implemented method of establishing fraud links between transactions comprises: collecting identifying data associated with at least one transaction in a set of fraudulent transactions; searching a second set of transactions for first linked transactions that include at least some of the identifying data; for each of the first linked transactions, recursively searching the second set of transactions for additional linked transactions based at least in part on additional identifying data included in each of the first linked transactions; designating a fraud island to include the at least one transaction, the first linked transactions, and the additional linked transactions; and determining whether at least one subsequent transaction is fraudulent based on the fraud island and a transaction fraud risk model.

In an embodiment, the identifying data and additional identifying data each comprise at least one of an account identifier; a device fingerprint; an email address; or a payment instrument identifier.

In an embodiment, the computer-implemented method further comprises: determining and storing a plurality of statistics for the transactions that comprise the fraud island; and determining a plurality of fraud risk model features for the fraud island based on the plurality of statistics.

In an embodiment, the plurality of statistics comprises at least one of: a date of an earliest fraudulent transaction; a date of a most recent fraudulent transaction; a number of fraudulent transactions; a total monetary amount of fraudulent transactions; a total number of transactions; a total number of non-fraudulent transactions; a total number of fraudulent transactions; a number of transactions undeterminable as fraudulent or non-fraudulent; a total monetary amount of the fraud island transactions; a non-fraudulent transaction monetary amount; a fraudulent transaction monetary amount; a monetary amount for the transactions undeterminable as fraudulent or non-fraudulent; and a length of time since a last occurring fraud in the fraud island.

In an embodiment, the computer-implemented method further comprises: providing the fraud risk model features to a feature store for the transaction fraud risk model.

In an embodiment, the determining whether subsequent transactions are fraudulent based on the fraud island and a transaction fraud risk model comprises: determining that a subsequent transaction has associated identifying data that links the pending transaction to the fraud island; causing the fraud risk model features to be provided as inputs to the transaction fraud risk model to generate a transaction risk score; and determining the subsequent transaction is fraudulent based at least in part on the transaction risk score.

In an embodiment, the computer-implemented method further comprises: aggregating the fraud risk model features to generate aggregated fraud risk model features for the fraud island; and providing the aggregated fraud risk model features to a feature store for the transaction fraud risk model.

In an embodiment, the determining whether subsequent transactions are fraudulent based on the fraud island and a transaction fraud risk model comprises: determining that a subsequent transaction has associated identifying data that links the pending transaction to the fraud island; causing the fraud island risk score to be input to the transaction fraud risk model to generate a transaction risk score; and determining the subsequent transaction is fraudulent based at least in part on the transaction risk score.

In an embodiment, the transaction fraud risk model comprises at least one of: a gradient decision boosting tree; an artificial neural network; or a deep neural network.

In another embodiment, a fraud detection system comprises: a transaction processor configured to receive a first transaction; a transaction linker configured to determine a link between the first transaction and a fraud island, the fraud island comprising a plurality of linked transactions that includes at least one transaction identified as fraudulent, each transaction of the fraud island linked to at least one other transaction of the fraud island by a common at least one of an account identifier, a device fingerprint, an email address, or a payment instrument identifier; and a fraud detector configured to determine the first transaction as fraudulent based on the fraud island and a transaction fraud risk model.

In an embodiment, the fraud detector is configured to determine the first transaction as fraudulent based on a transaction risk score generated by the transaction fraud risk model based on a plurality of fraud risk model features provided as input to the transaction fraud risk model, the fraud risk mode features being including statistics of the fraud island.

### V. CONCLUSION

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A fraud detection system, comprising:
one or more processors; and
one or more memory devices accessible to the one or more processors, the one or more memory devices storing program code for execution by the one or more processors, the program code including:
a data collector configured to collect identifying data associated with at least one transaction in a set of fraudulent transactions;
a transaction linker configured to search a second set of transactions for first linked transactions that include at least some of the identifying data, and to recursively search the second set of transactions for additional linked transactions based at least in part on additional identifying data included in each of the first linked transactions, wherein the at least one transaction, the first linked transactions and the additional linked transactions comprise a fraud island; and
a fraud detector configured to determine whether subsequent transactions are fraudulent based on the fraud island and a transaction fraud risk model.

2. The fraud detection system of claim 1, wherein the identifying data and additional identifying data each comprise at least one of:
an account identifier;
a device fingerprint;
an email address; or
a payment instrument identifier.

3. The fraud detection system of claim 1, further comprising:
a fraud island statistics generator configured to determine and store a plurality of statistics for the transactions that comprise the fraud island, and to determine a plurality of fraud risk model features for the fraud island based on the plurality of statistics.

4. The fraud detection system of claim 3, wherein the plurality of statistics comprises at least one of:
a date of an earliest fraudulent transaction;
a date of a most recent fraudulent transaction;
a number of fraudulent transactions;
a total monetary amount of fraudulent transactions;
a total number of transactions;
a total number of non-fraudulent transactions;
a total number of fraudulent transactions;
a number of transactions undeterminable as fraudulent or non-fraudulent;
a total monetary amount of the fraud island transactions;
a non-fraudulent transaction monetary amount;
a fraudulent transaction monetary amount;
a monetary amount for the transactions undeterminable as fraudulent or non-fraudulent; and
a length of time since a last occurring fraud in the fraud island.

5. The fraud detection system of claim 3, wherein the fraud island statistics generator is further configured to:
provide the fraud risk model features to a feature store for the transaction fraud risk model.

6. The fraud detection system of claim 5, wherein the transaction linker is further configured to:
determine that a subsequent transaction has associated identifying data that links the pending transaction to the fraud island; and
the fraud detector is further configured to:
cause the fraud risk model features to be provided as inputs to the transaction fraud risk model to generate a transaction risk score; and
determine the subsequent transaction is fraudulent based at least in part on the transaction risk score.

7. The fraud detection system of claim 3, wherein the fraud island statistics generator is further configured to:
aggregate the fraud risk model features to generate aggregated fraud risk model features for the fraud island; and
provide the aggregated fraud risk model features to a feature store for the transaction fraud risk model.

8. The fraud detection system of claim 7, wherein the transaction linker is further configured to:
determine that a subsequent transaction has associated identifying data that links the pending transaction to the fraud island;
the fraud detector is further configured to:
cause the fraud island risk score to be input to the transaction fraud risk model to generate a transaction risk score; and
determine the subsequent transaction is fraudulent based at least in part on the transaction risk score.

9. The fraud detection system of claim 1, wherein the transaction fraud risk model comprises at least one of:
a gradient decision boosting tree;
an artificial neural network; or
a deep neural network.

10. A computer-implemented method of establishing fraud links between transactions, comprising:
collecting identifying data associated with at least one transaction in a set of fraudulent transactions;
searching a second set of transactions for first linked transactions that include at least some of the identifying data;
for each of the first linked transactions, recursively searching the second set of transactions for additional linked transactions based at least in part on additional identifying data included in each of the first linked transactions;
designating a fraud island to include the at least one transaction, the first linked transactions, and the additional linked transactions; and
determining whether at least one subsequent transaction is fraudulent based on the fraud island and a transaction fraud risk model.

11. The computer-implemented method of claim 10, wherein the identifying data and additional identifying data each comprise at least one of:
an account identifier;
a device fingerprint;
an email address; or
a payment instrument identifier.

12. The computer-implemented method of claim 10, further comprising:
determining and storing a plurality of statistics for the transactions that comprise the fraud island; and
determining a plurality of fraud risk model features for the fraud island based on the plurality of statistics.

13. The computer-implemented method of claim 12, wherein the plurality of statistics comprises at least one of:
a date of an earliest fraudulent transaction;
a date of a most recent fraudulent transaction;
a number of fraudulent transactions;
a total monetary amount of fraudulent transactions;
a total number of transactions;
a total number of non-fraudulent transactions;
a total number of fraudulent transactions;
a number of transactions undeterminable as fraudulent or non-fraudulent;
a total monetary amount of the fraud island transactions;
a non-fraudulent transaction monetary amount;
a fraudulent transaction monetary amount;
a monetary amount for the transactions undeterminable as fraudulent or non-fraudulent; and
a length of time since a last occurring fraud in the fraud island.

14. The computer-implemented method of claim 12, further comprising:
providing the fraud risk model features to a feature store for the transaction fraud risk model.

15. The computer-implemented method of claim 14, wherein said determining whether subsequent transactions are fraudulent based on the fraud island and a transaction fraud risk model comprises:
determining that a subsequent transaction has associated identifying data that links the pending transaction to the fraud island;
causing the fraud risk model features to be provided as inputs to the transaction fraud risk model to generate a transaction risk score; and
determining the subsequent transaction is fraudulent based at least in part on the transaction risk score.

16. The computer-implemented method of claim 12, further comprising:
aggregating the fraud risk model features to generate aggregated fraud risk model features for the fraud island; and
providing the aggregated fraud risk model features to a feature store for the transaction fraud risk model.

17. The computer-implemented method of claim 16, wherein said determining whether subsequent transactions are fraudulent based on the fraud island and a transaction fraud risk model comprises:
determining that a subsequent transaction has associated identifying data that links the pending transaction to the fraud island;
causing the fraud island risk score to be input to the transaction fraud risk model to generate a transaction risk score; and
determining the subsequent transaction is fraudulent based at least in part on the transaction risk score.

18. The computer-implemented method of claim 10, wherein the transaction fraud risk model comprises at least one of:
a gradient decision boosting tree;
an artificial neural network; or
a deep neural network.

19. A fraud detection system, comprising:
a transaction processor configured to receive a first transaction;
a transaction linker configured to determine a link between the first transaction and a fraud island, the fraud island comprising a plurality of linked transactions that includes at least one transaction identified as fraudulent, each transaction of the fraud island linked to at least one other transaction of the fraud island by a common at least one of an account identifier, a device fingerprint, an email address, or a payment instrument identifier; and
a fraud detector configured to determine the first transaction as fraudulent based on the fraud island and a transaction fraud risk model.

20. The fraud detection system of claim 19, wherein the fraud detector is configured to determine the first transaction as fraudulent based on a transaction risk score generated by the transaction fraud risk model based on a plurality of fraud risk model features provided as input to the transaction fraud risk model, the fraud risk mode features being including statistics of the fraud island.
